(19) United States
(12) Patent Application Publication
(10) Pub. No.: US 2016/0059265 A1
(43) Pub. Date: Mar. 3, 2016

(54) USE OF PULSED THERMAL RADIATION AND NANO-PARTICLES FOR THE EFFECTIVE GENERATION OF SOUND WAVES IN KHZ RANGE

(71) Applicant: JEJU NATIONAL UNIVERSITY INDUSTRY-ACADEMIC COOPERATION FOUNDATION, Jeju-si (KR)

(72) Inventors: Wongee CHUN, Jeju-si (KR); Seungjin OH, Jeju-si (KR); Namjin KIM, Jeju-si (KR); Youncheol PARK, Jeju-si (KR); Yeongmin KIM, Seogwipo-si (KR); Kuan CHEN, Salt Lake City, UT (US)

(21) Appl. No.: 14/471,897

(22) Filed: Aug. 28, 2014

(30) Foreign Application Priority Data
Aug. 28, 2014 (KR) 10-2014-0113022

(51) Int. Cl. B06B 1/00

(52) U.S. Cl. CPC B06B 1/00

(57) ABSTRACT

Disclosed herein is a high-efficiency kilohertz-range acoustic wave generator using a pulsed thermal radiation beam and nanoparticles. A vibration (pulse) generating means having a suspension structure is provided behind a light interrupter. The suspension structure is configured such that nanoparticles are suspended in a solution so that when the nanoparticles are thermally expanded by pulse beams directly applied to the nanoparticles and are thermally contracted, the solution vibrates (generates matter waves and pressure waves). Thereby, loss of pulse beams can be minimized, and energy having a relatively large wavelength can be easily obtained. Therefore, the efficiency and productivity in generating acoustic waves can be maximized.

### BACKGROUND OF THE INVENTION

1. Field of the Invention

The present invention relates to a high-efficiency kilohertz-range acoustic wave generator using a pulsed thermal radiation beam and nanoparticles in which a vibration (pulse) generating means having a suspension structure is provided behind a light interrupter, wherein the suspension structure is configured such that nanoparticles are suspended in a solution so that when the nanoparticles are thermally expanded by pulse beams directly applied to the nanoparticles and are thermally contracted, the solution vibrates (generates matter waves and pressure waves). Thereby, loss of pulse beams can be minimized, and energy having a relatively large wavelength can be easily obtained. Therefore, the efficiency and productivity in generating acoustic waves can be maximized.

The present invention is configured to generate high-frequency (ultrasonic) waves from obtained acoustic waves and provide the acoustic waves to a variety of industrial fields including fields pertaining to sterilization, washing, etc.

2. Description of the Related Art

Generally, solar energy is used for air-conditioning or heating of buildings, lighting devices or power generation.

With regard to this, over the past half century studies on solar energy have been continuously conducted and many related techniques have already been commercialized. At present, various forms of solar energy conversion systems for improvement in efficiency are under study.

Meanwhile, the conversion of solar energy into acoustic energy, along with a solar tracking system, is opening a new chapter in technology using high-density solar energy. Most of this technology is focused on the development of thermoacoustic refrigerators.

Conventional thermoacoustic wave generators using solar light are configured such that a porous stack (solid block) is disposed in a transparent tube closed on one end thereof and thermoacoustic waves are generated by heating a portion thereof adjacent to the closed end of the transparent tube.

However, in conventional thermoacoustic wave generators, to generate high-frequency thermoacoustic waves, the size of the transparent tube must be reduced inversely proportional to the frequency of thermoacoustic waves, and a high thermal gradient between both ends of the porous stack must be maintained. Therefore, in practice it is very difficult to embody such conventional thermoacoustic wave generators. Referring to the result of research so far, it has been reported that the University of Utah, USA succeeded in producing a maximum acoustic wave of 3 kHz via this conventional technique.

In other words, it is no exaggeration to say that it is almost impossible to produce thermoacoustic waves in an ultrasonic wave range of 18 kHz or more using the above conventional technique.

Furthermore, research on generating thermoacoustic waves has focused on generating compression waves via a process of heating a very small micro-sized structure by momentarily applying Joule's heat resulting from electric energy to the structure and then cooling the structure. This process is repeated so that air surrounding the structure is expanded and cooled.

In an effort to overcome the problems of the conventional techniques pertaining to thermoacoustic wave generators, the applicant of the present invention proposed a thin metal plate membrane structure in Korean Patent Registration No. 10-1207380.

However, the technique of No. 10-1207380 is problematic in that the efficiency in producing high frequency is comparatively low because some solar light transmitted through a hole is lost in the air before it reaches the membrane structure. In addition, the size of a light interrupter must be greatly increased depending on the size of the thin metal plate. Therefore, it is substantially difficult to commercialize the technique.

### SUMMARY OF THE INVENTION

Accordingly, the present invention has been made keeping in mind the above problems occurring in the prior art, and an object of the present invention is to provide a high-efficiency kilohertz-range acoustic wave generator in which a vibration (pulse) generating means having a suspension structure is provided behind a light interrupter, wherein the suspension structure is configured such that nanoparticles are suspended in a solution so that when the nanoparticles are thermally expanded by pulse beams directly applied to the nanoparticles and are thermally contracted, the solution vibrates (generates matter waves and pressure waves). Thereby, loss of pulse beams can be minimized, and energy having a relatively large wavelength can be easily obtained. Therefore, the efficiency and productivity in generating acoustic waves can be maximized.

Another object of the present invention is to provide a high-efficiency kilohertz-range acoustic wave generator that is configured to generate high-frequency (ultrasonic) waves from obtained acoustic waves and provide the acoustic waves to a variety of industrial fields including fields pertaining to sterilization, washing, etc.

In order to accomplish the above object, the present invention provides a high-efficiency kilohertz-range acoustic wave generator using a pulsed thermal radiation beam and nanoparticles, including: a focusing tube focusing solar light collected by a solar tracking reflector to form high-density light and emitting the focused solar light; a light interrupter including a circular disk and a rotating drive unit, the circular disk having a plurality of holes arranged at positions spaced apart from each other at regular intervals in a circumferential direction around the rotating drive unit so that solar light emitted from the focusing tube passes through the holes and thus is intermittently emitted, and a pulse beam is formed by intermittent solar light that has passed through one of the holes of the light interrupter; a suspension structure including a container filled with a transparent solution, and a glass panel provided on an end of the container, the suspension structure being configured such that the pulse beam is directly transmitted into the container through the glass panel, wherein nanoparticles are suspended in the transparent solution of the container and are thermally-expanded by pulse beams and thermally-contracted (repeatedly deformed), thus making the solution generate vibration pulses; and a wave guide coupled to an end of the container that is opposed to the glass panel, the wave guide being configured to transmit acoustic waves to a desired place of use.

The nanoparticles may be made of phase change material that can liquefy or coagulate.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view showing the application of an acoustic wave generator according to the present invention; and

FIG. 2 is a view illustrating a suspension structure according to the present invention.

### DESCRIPTION OF THE PREFERRED EMBODIMENTS

Hereinafter, the present invention will be described in detail with reference to the attached drawings.

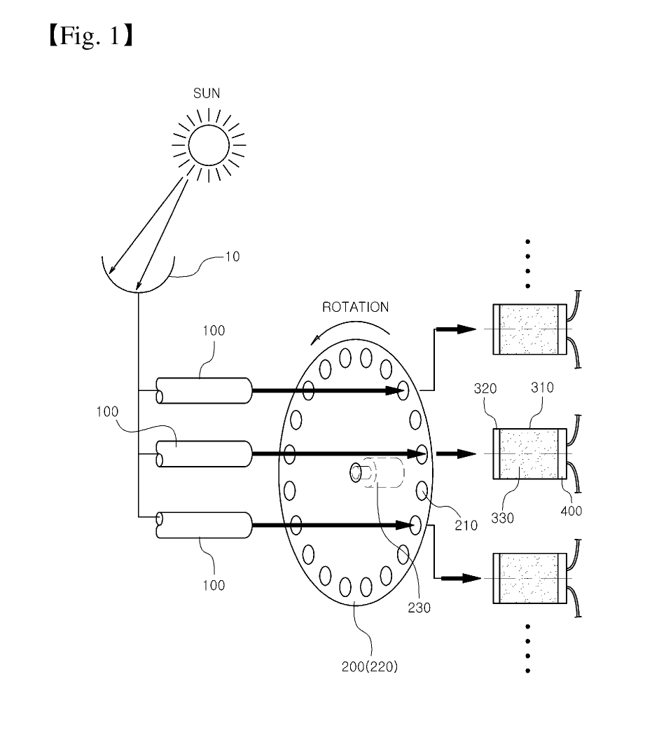

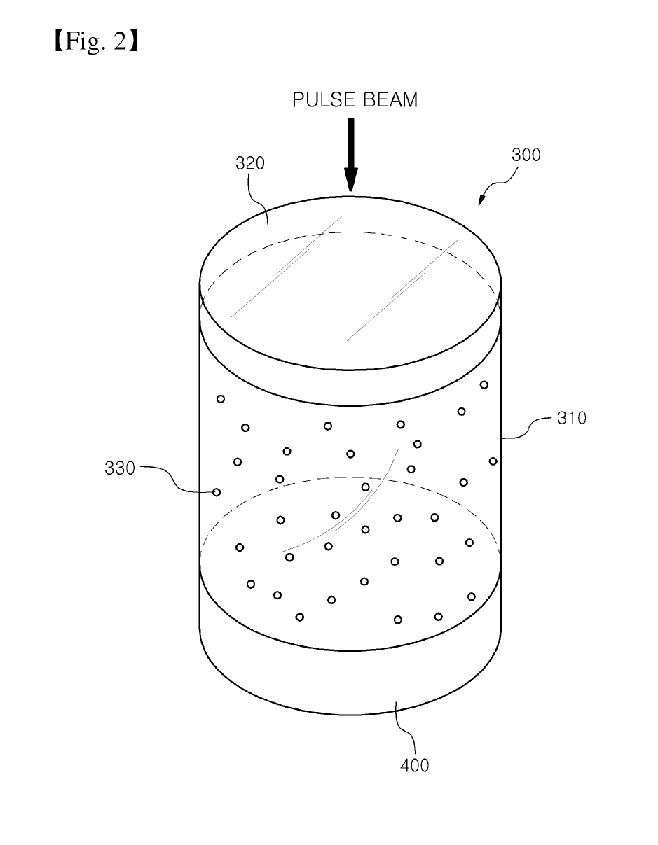

As shown in FIGS. 1 and 2, a high-efficiency acoustic wave generator according to the present invention includes a focusing tube 100, a light interrupter 200, a suspension structure 300 and a wave guide 400.

The focusing tube 100 focuses solar light collected by a solar tracking reflector to form high-density light and emits the focused light. The light interrupter 200 includes a circular disk 220 and a rotating drive unit 230. The circular disk 220 has a plurality of holes 210 that are arranged at positions spaced apart from each other at regular intervals in the circumferential direction around the rotating drive unit 230. Solar light emitted from the focusing tube 100 passes through the holes 210 so that the solar light is intermittently applied to the suspension structure 300.

As shown in FIG. 1, the holes 210 formed at regular intervals around the perimeter of the circular disk 220 of the light interrupter 200 cause light to intermittently pass through the circular disk 220, thus making a pulse beam. Depending on the number of holes 210 and the RPM of the circular disk 220, the frequency of the pulse beam is determined.

The suspension structure 300 includes a container 310 filled with a transparent solution, and a glass panel 320 provided on an end of the container 310. The suspension structure 300 is configured such that a pulse beam formed by intermittently passing solar light through the holes 210 of the light interrupter 200 is directly transmitted into the container 310 through the glass panel 320. Many nanoparticles 330 are suspended in the solution of the container 310. The nanoparticles 330 are thermally-expanded by pulse beams and thermally-contracted (repeatedly deformed), thus making the solution generate vibration pulses.

The wave guide 400 is coupled to the end of the container 310 that is opposed to the glass panel 320. The wave guide 400 is configured to transmit acoustic waves to a desired place of use.

Preferably, the nanoparticles 330 are made of a phase change material that can liquefy or coagulate.

It is preferable that the nanoparticles 330 be made of carbon nanotubes or zinc oxide having a high thermal expansion coefficient.

Furthermore, the nanoparticles 330 may be aluminum particles each of which has a diameter ranging from 0.1 μm to 1 μm and is superior in a light absorption coefficient, a thermal expansion coefficient and heat radiation performance.

Preferably, a vibrator (not shown) is provided at a predetermined position in the container 310 of the suspension structure 300 so that the nanoparticles 330 suspended in the solution can be prevented from settling.

Furthermore, the focusing tube 100 according to the present invention has a structure divided from the reflector into a plurality of focusing tubes 100, preferably, the number of which corresponds to the number of holes in the light interrupter 200. Connected to a converter, terminals (suspension structures having nanoparticles) respectively matching with the focusing tubes are disposed at a side opposite to the focusing tubes based on the light interrupter 200. A variety of wavelengths of light caused due to the characteristics of solar light are synchronized (integrated) with each other by the converter so that the output power is collected.

In other words, although electric energy generally has a single laser pulse wavelength, solar light has a variety of wavelengths of rays including infrared rays, ultraviolet rays, etc. Given this, when solar light is input to the terminals divided into several parts, a variety of wavelengths of light are collected by the converter, whereby the output power can be increased.

The nanoparticles according to the present invention are material having low latent heat. Hence, although relatively small energy is applied to the nanoparticles, sufficient output (in density and volume) can be obtained.

Phase changes (evaporation, liquefaction, sublimation, etc.) of such nanoparticles are easily caused by virtue of low latent heat thereof. Therefore, the nanoparticles can easily absorb energy from solar light and increase the amplitudes of wavelengths of acoustic waves resulting from phase changes, thus making it possible to increase the output of acoustic waves.

In other words, the present invention is advantageous in that various embodiments and modifications in application of nanoparticles are possible because solar light, which is high-frequency energy and has a variety of wavelengths, is used as an energy source.

As described above, in a high-efficiency kilohertz-range acoustic wave generator according to the present invention, a vibration (pulse) generating means having a suspension structure is provided behind a light interrupter. The suspension structure is configured such that nanoparticles are suspended in a solution so that when the nanoparticles are thermally expanded by pulse beams directly applied to the nanoparticles and are thermally contracted, the solution vibrates (generates matter waves and pressure waves). Thereby, loss of pulse beams can be minimized, and energy having a relatively large wavelength can be easily obtained. Therefore, the efficiency and productivity in generating acoustic waves can be maximized.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A high-efficiency kilohertz-range acoustic wave generator using a pulsed thermal radiation beam and nanoparticles, comprising:
a focusing tube (100) focusing solar light collected by a solar tracking reflector (10) to form high-density light and emitting the focused solar light;
a light interrupter (200) including a circular disk (220) and a rotating drive unit (230), the circular disk (220) having a plurality of holes (210) arranged at positions spaced apart from each other at regular intervals in a circumferential direction around the rotating drive unit (230) so that solar light emitted from the focusing tube (100) passes through the holes (210) and thus is intermittently emitted, and a pulse beam is formed by intermittent solar light that has passed through one of the holes (210) of the light interrupter;
a suspension structure (300) including a container (310) filled with a transparent solution, and a glass panel (320) provided on an end of the container (310), the suspension structure (300) being configured such that the pulse beam is directly transmitted into the container (310) through the glass panel (320), wherein nanoparticles (330) are suspended in the transparent solution of the container (310) and are thermally-expanded by pulse beams and thermally-contracted (repeatedly deformed), thus making the solution generate vibration pulses; and
a wave guide (400) coupled to an end of the container (310) that is opposed to the glass panel (320), the wave guide (400) being configured to transmit acoustic waves to a desired place of use.

2. The high-efficiency kilohertz-range acoustic wave generator as set forth in claim 1, wherein the nanoparticles (330) are made of phase change material that can liquefy or coagulate.
